(19) United States
(12) Patent Application Publication
(10) Pub. No.: US 2016/0376130 A1
(43) Pub. Date: Dec. 29, 2016

(54) A LIFTING DEVICE

(71) Applicants: Dirk MUELLER, Muelheim a.d.Ruhr (DE); Tao XU, Minhang District, Shanghai (CN); Chao MA, Minhang District, Shanghai (CN); Frank WITTIG, Bottrop (DE); Claus VOEGELIN, Muelheim an der Ruhr (DE); SIEMENS AKTIENGESELLSCHAFT, Munich (DE)

(72) Inventors: Chao MA, Shanghai (CN); Dirk MUELLER, Muelheim a.d.Ruhr (DE); Claus VOEGELIN, Muelheim an der Ruhr (DE); Frank WITTIG, Bottrop (DE); Tao XU, Shanghai (CN)

(73) Assignee: Siemens Aktiengesellschaft, Muenchen (DE)

(21) Appl. No.: 15/039,874

(22) PCT Filed: Nov. 29, 2013
(86) PCT No.: PCT/CN2013/088239

§ 371 Date: May 27, 2016

(51) Int. Cl. B66C 1/62

(52) U.S. Cl. CPC B66C 1/62

(57) ABSTRACT

A device is provided for lifting equipment including a plurality of outwardly extending struts each of which includes a head portion and a root portion connected to the head portion; and a plurality of separate connection parts, the connection parts being capable of being connected at a first position and a second position to the head portion of the struts. The first position and the second position are located two respective sides of a central axis of the strut, so that the first position and the second position are respectively capable of bearing the gravity load of the equipment and balancing the stress loads which the struts incur when the equipment is lifted by the device.

### PRIORITY STATEMENT

This application is the national phase under 35 U.S.C. §371 of PCT International Application No. PCT/CN2013/088239 which has an International filing date of Nov. 29, 2013, which designated the United States of America, the entire contents of which are hereby incorporated herein by reference.

### FIELD

An embodiment of the present invention relates to the field of mechanical devices, and more particularly to lifting devices of heavy equipment such as a steam turbine, a gas turbine, a generator, a motor, and a compressor.

### BACKGROUND

During installation or maintenance, heavy equipment such as a steam turbine, a gas turbine, a generator, a motor, and a compressor often needs to be lifted (including the operations of moving from a lower to a higher position and vice versa). Some automatic lifting devices exist, but these lifting devices usually cannot be used to lift equipment that is heavy. For example, during assembly of a gas turbine, if a rotor and an exhaust casing can be lifted together, assembly costs can be reduced greatly, and assembly efficiency can be improved.

However, currently during lifting, when lifting points (that is, lifting positions) are disposed on struts of a star-shaped exhaust casing, some struts of the exhaust casing are likely to deform or be damaged due to heavy loads applied to them. Therefore, currently, the lifting point can only be set on the rotor. A device capable of lifting the exhaust casing and the rotor together without damaging struts of the exhaust casing is not available yet. Similarly, during lifting of other star-shaped heavy equipment, this phenomenon also occurs in which some struts deform or is damaged during lifting operation because loads are concentrated on the struts.

### SUMMARY OF THE INVENTION

An embodiment of the present invention provides a device for lifting equipment having a plurality of outwardly extending struts each of which comprises a head portion and a root portion connected to the head portion, the device being characterized in comprising a plurality of separate connection parts, the connection parts being capable of being connected at a first position and a second position to the head portion of the struts, and the first position and the second position being located two sides of the central axis of the strut respectively, so that the first position and the second position are respectively capable of bearing the gravity load of the equipment and balancing the stress load which the strut incurs when the equipment is lifted by the device. It should be noted that “a first position and a second position” does not mean there is only one first position and one second position.

In an embodiment of the present invention, a plurality of separate connection parts are used to fix a plurality of outwardly extending struts of star-shaped equipment respectively, so that the gravity load can be distributed to multiple struts of the star-shaped equipment. In this manner, the situation where the gravity load is concentrated on a strut is avoided. Meanwhile, the manner of the connection on two sides of the central axis of the root portion of one strut can balance the local load, which is mainly stress incurred at the junction of the root portion and the head portion of the strut, incurred during lifting operation. It should be noted that the position that balances the local load incurred in lifting operation is likely to also bear a certain part of the gravity load. However, in the embodiment of the present invention, the main function of the position is to balance the local load incurred.

In an embodiment, the connection parts further have third positions at one end thereof, and the third positions of two adjacent connection parts are located on two sides of a central axis of the root portion of one strut, so that the head portion of one strut is capable of connecting two adjacent connection parts at the third positions.

In the above embodiment, the third positions of two adjacent connection parts are connected to one strut, so as to connect the adjacent connection parts. In this way, during lifting of equipment that is heavy, a connection part may be connected to two struts, so that the gravity load of the equipment can be distributed to more struts instead of one. Therefore, more struts can bear the gravity load, thereby protecting the struts from being damaged.

In an embodiment, each of the connection parts has two pairs of a first position and a second position, so that each of the connection parts is capable of connecting to two struts.

The embodiment enables a connection part to connect two struts. In this manner more struts will bear the gravity load of the equipment.

In an embodiment, the head portion of the strut has connection mechanisms at the first position and the second position respectively, and the connection part has a first group of connection mechanisms and a second group of connection mechanisms whose positions correspond to those of the connection mechanisms of the head portion of the strut respectively, so that the connection part is capable of being connected to the strut at the first position and the second position respectively.

In an embodiment, the first group of connection mechanisms and the second group of connection mechanisms of the connection part and the connection mechanisms of the head portion of the strut are all holes.

In an embodiment, one of the first group of connection mechanisms and the second group of connection mechanisms of the connection part forms a tight connection with the connection mechanisms of the head portion of the strut, so that one position among the first position and the second position is capable of bearing the gravity load of the equipment.

The tight connection between one of the first group of connection mechanisms and the second group of connection mechanisms of the connection part and the connection mechanisms of the head portion of the strut makes the connection part in close contact with the strut, so as to ensure that the strut can bear the gravity load at the corresponding first position or second position. It should be noted that, the so-called “tight connection” refers to that two connection mechanisms are connected together with no substantial space for movement.

In an embodiment, the other of the first group of connection mechanisms and the second group of connection mechanisms is capable of being connected to the connection mechanisms on the head portion of the strut by using connection components. so that the other position among the first position and the second position can balance the local load incurred in lifting operation. Besides, the diameters of the connection components are smaller than the diameters of the connection mechanisms on the head portion of the strut, and are also smaller than the diameters of the first group of connection mechanisms or the second group of connection mechanisms which is connected to the connection components.

In the embodiment of the present invention, the stress incurred at the junction of the head portion and the root portion of the strut of the equipment can be reduced or eliminated, thereby protecting the strut. Manufacturing errors always occur in mechanical manufacturing. When multiple tight connection fits exist between two components, it is difficult or even impossible to perform assembly, because it is difficult to align or pair connection mechanisms which are fitted later than others, thereby making it difficult to perform assembly. To facilitate the connection of the connection part and the strut in an embodiment of the present invention, in an embodiment of the present invention, the diameter of the connection components such as a pin is smaller than the diameter of the connection mechanisms on the connection part and the strut connected to the pin, thereby facilitating connection and fixing.

In an embodiment, the connection part is provided with a third connection mechanism at the third position, and two adjacent connection parts are connected at the third positions to the head portion of a strut through the third connection mechanisms, so that the third positions may not only bear the gravity load of the equipment, but also balance the stress load incurred in lifting operation.

In an embodiment, the first position and the second position of the connection part are symmetrically located relative to the central axis of the root portion of a strut, and the third positions of the two adjacent connection parts for connecting to the head portion of a strut are symmetrical relative to the central axis of the root portion of the strut.

In an embodiment, the connection parts are arc. A lifting point of the equipment is located between the third position of the connection part and the first position or the second position which is closer to the third position. The equipment is a combination of an exhaust casing and a rotor of a gas turbine.

### BRIEF DESCRIPTION OF THE DRAWINGS

The following accompanying drawings are only intended to schematically illustrate and explain embodiments of the present invention, but are not intended to limit the scope of the present invention, where:

FIG. 1 is a schematic view of an embodiment of the present invention;

FIG. 2 is a sectional view along a line X1-X1 at a first position in FIG. 1;

FIG. 3 is a sectional view along a line X2-X2 at a second position in FIG. 1; and

FIG. 4 is a schematic view of another embodiment of the present invention.

### LIST OF REFERENCE NUMERALS

1 Strut

2 Equipment

3 Head portion

4 Root portion

5 First group of connection mechanisms

6 Second group of connection mechanisms

7 Connection part

8, 9 Connection mechanisms on a strut

10 Pin

11 Bolt

12 Pulling part

A, B, E, F First position and second position

C, D Third position

### DETAILED DESCRIPTION OF THE INVENTION

To make the technical features, objectives, and effects of the present invention be understood more clearly, embodiments of the present invention are illustrated with reference to the accompanying drawings.

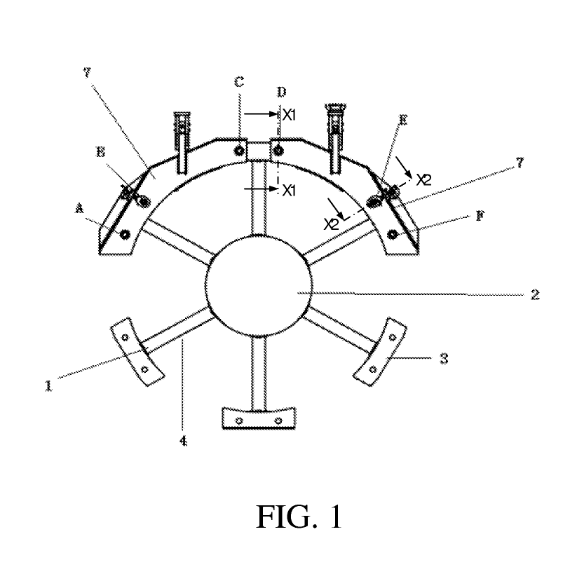

FIG. 1 is a schematic view of an embodiment according to the present invention. As shown in FIG. 1, the to-be-lifted equipment is substantially star-shaped, the equipment has a plurality of outwardly extending struts 1, and the struts 1 are spatially separate. The strut 1 is hammer-shaped, and has a head portion 3 and a root portion 4. For example, a turbine-side bearing housing of a gas turbine has the star-shaped structure. A rotor and the bearing housing are connected together through a bearing, the bearing housing is located in an exhaust casing, multiple struts extend, in a circumferential direction, from an inner wall of the turbine, and outer ends of the struts extend out of an outer wall of the turbine. The strut has a root portion extending along the radial direction of the turbine and a head portion connected to the outer end of the root portion.

In order to lift heavy equipment having the foregoing structure during installation or maintenance, an embodiment of the present invention provides a device, and the device has a plurality of separate connection parts 7. The shape of the connection part 7 may be any as long as the connection part 7 and the head portion 3 of the strut 1 can be connected together. To facilitate lifting of an exhaust casing and a rotor of a cylindrical gas turbine (the rotor causes the gravity load in lifting operation to be very big), the connection parts 7 are in the shape of arc, in order to prevent interference between the connection parts 7 and a casing body. The connection parts 7 may also be selectively in the forms such as a beam and a plate corresponding to the shape of the to-be-lifted equipment. Stiffness of the connection parts needs to be high, and a specific stiffness value may be determined according to a maximum load incurred during lifting. The number of the connection parts 7 may be selected according to the number of the struts 1. For example, referring to FIG. 1, when the to-be-lifted equipment has 6 struts, a device having two connection parts 7 may be used.

The connection part 7 of the lifting device may be connected, at a first position and a second position A, B, to the head portion 3 of a strut, and the first position and the second position A, B are located on two sides of a central axis of the root portion 4 of the strut respectively. When the device is used to lift the equipment 2, the first position is capable of bearing the gravity load of the equipment 2, and the second position is capable of balancing a local load (mainly stress incurred at the junction of the head portion and the root portion of the strut) incurred during lifting. In this manner, a plurality of separate connection parts 7 are connected to multiple struts, so as to distribute the gravity load of the equipment to more than one strut, and meanwhile balance the local load incurred during lifting, thereby better protecting the struts of the to-be-lifted equipment from damaging. Since the connection part 7 and the strut 1 are in contact with each other at the second position, the second position is very likely to bear a certain part of the gravity load of the equipment.

Alternatively, the first position may have the function of balancing the local load incurred by the lifting, and the second position may have the function of bearing the gravity load of the equipment 2. In all examples in the following description, the first position has the function of bearing the gravity load of the equipment and the second position has the function of balancing the load incurred by the lifting, and the case in which the first position has the function of balancing the local load incurred during lifting and the second position has the function of bearing the gravity load of the equipment is not described.

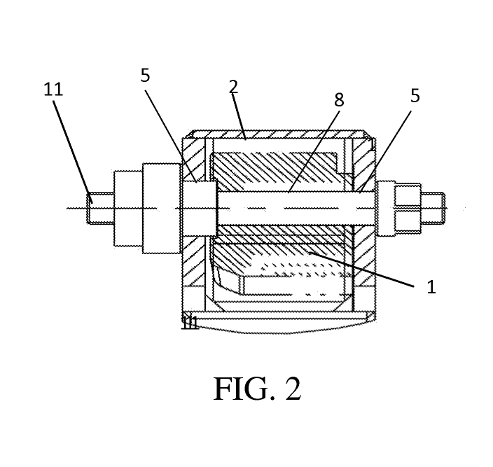

As shown in FIG. 2, the head portion 3 of the strut has connection mechanisms 8, 9, such as holes, at the first position and the second position A, B respectively, and the connection mechanisms 8, 9 may be structures that the head portion 3 of the strut has, and may also be machined for lifting operation during installation or maintenance. The connection part 7 has a first group of connection mechanisms and a second group of connection mechanisms 5, 6 whose positions correspond to positions of the connection mechanisms 8, 9 of the head portion 3 of the strut respectively, and the first group of connection mechanisms and the second group of connection mechanisms 5, 6 may also be holes. Through the connection mechanisms 8, 9 of the head portion 3 of the struts and the first group of connection mechanisms and the second group of connection mechanisms 5, 6, the connection part 7 can be connected to the strut 1 at the first position and the second position A, B respectively. As shown in FIG. 2, bolts 11 may be used to connect the connection mechanisms 8, 9 on the head portion 3 of the strut to the first connection structure and the second connection structure 5, 6 of the connection part 7 respectively. Definitely, connection parts, such as a steel wire rope and a fixture, may be used to replace the bolt 11 to achieve the foregoing connection.

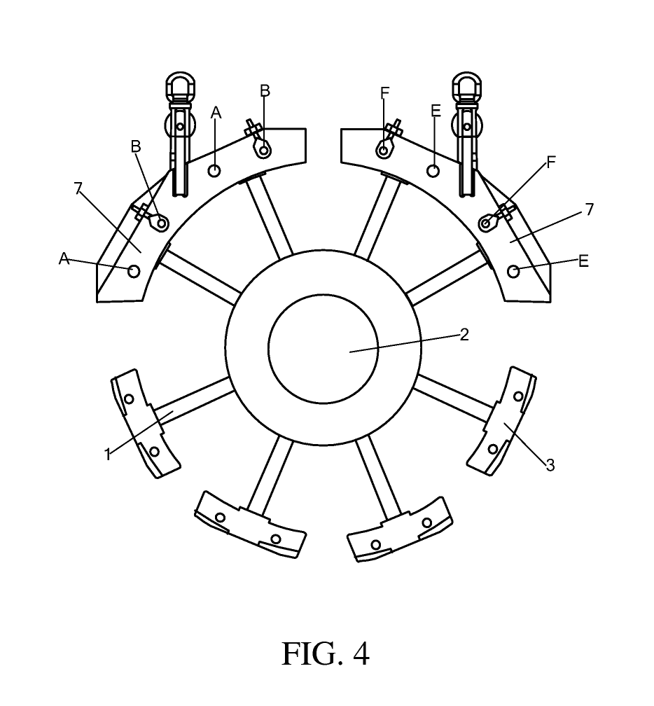

As shown in FIG. 1 and FIG. 4, preferably, the connection parts 7 further have third positions C, D at one of its end, so that two adjacent connection parts 7 may be connected at their third positions C, D to the head portion 3 of a strut. The third positions of the two connection parts 7 are located on two sides of the central axis of the root portion of the strut that connect the two connection parts 7, so that the two adjacent connection parts 7 can be connected together through the head portion 3 of a strut. A connection part 7 is connected to two struts 1, so that the gravity load of the lifted equipment is distributed to three struts 1 (that is, the three struts 1 connected to the two connection parts 7 as shown in FIG. 1). Persons skilled in the art may figure out multiple manners in which two connection parts 7 and the head portion 3 of a strut are connected at the third positions C, D at one end of the two connection parts 7. For example, two connection parts 7 may be provided with third connection structures, such as holes, at the third positions C, D of one end of the two connection parts 7, so that the two connections part 7 and a strut 1 may be connected and fixed at the third positions through fasteners such as the bolts 11. Therefore, the connection parts 7 and the strut 1 may, at the two third positions, not only have the function of bearing the gravity load of the equipment but also have the function of balancing the load incurred by the lifting.

Preferably, the third positions C, D of two adjacent connection parts 7 for connecting to the head portion 3 of a strut are symmetrical relative to the central axis of the root portion 4 of the strut. In this way, local stress incurred at third positions by adjacent connection parts 7 connected to a strut 1 can be better balanced.

In the embodiment where the connection part 7 has the third position, a lifting point may be selected to be located between the third position C, D of the connection part 7 and the first position or the second position A, B which is closer to the third position. For example, as shown in FIG. 1, the lifting point may be located between the second position B and the third position C, or between a second position E and the third position D, and the selection of the lifting point at the above position makes it easier to balance the device.

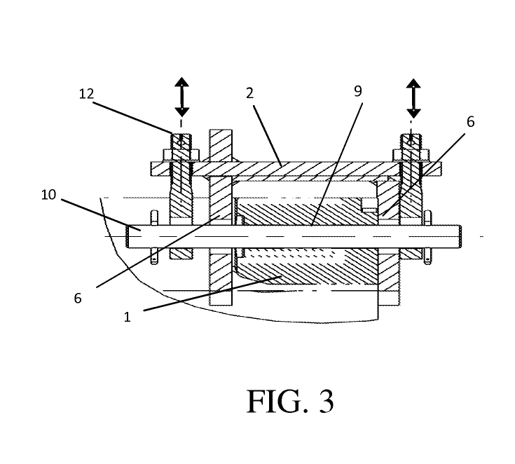

An embodiment in which the connection parts 7 and the strut 1 are connected at the first position and the second position A, B and the third positions C, D is illustrated below with reference to FIG. 2 and FIG. 3. It should be noted that the connection manner herein is only a preferred one. First, at the first positions (herein, A and F are first positions, and B and E are second positions) and the third positions C, D, bolts 11 may be used as connection parts and inserted into the connection mechanisms 8, 9 (for example, holes) on the head portions 3 of the struts and holes at the first positions A, F and the third positions C, D on the connection parts 7, and then nuts are used and tightened, so as to fix the connection parts 7 and the strut 1 at the third positions. A tight fit should be formed at the first positions A, F and the third positions C, D. If a gap between two connection mechanisms is too large, the strut 1 may not contact some positions of the connection part 7 (for example, the first position A, or the first position F, or the third positions C, D), so that the gravity load may be concentrated on an individual strut. Further, at the second positions B, E connection components such as pins 10, may be used to enable the connection parts 7 and the head portions 3 of the struts to be connected at the second positions, so that the second positions B, E can balance the local load incurred during lifting. That is, the second position B is used to balance bending moment incurred at the first position A, and the second position E is used to balance bending moment incurred at the first position F. This means the function of the second positions B, E is to limit displacement of the head portions 3 of the struts, and fix the head portions 3 of the struts on the connection parts 7. It should be noted that, the second positions B, E are very likely to bear a certain part of the gravity load.

To facilitate assembly, the diameters of the pins 10, which are the connection components used at the second positions B, E, are smaller than the diameters of the connection mechanisms 8, 9 (for example, holes) on the head portions 3 of the struts, and are also smaller than the diameters of the second group of connection mechanisms connected to the pins 10. Gaps exist between the pins 10 and the connection mechanisms 8, 9 of the struts and between the pins 10 and the second group of connection mechanisms of the connection part 7, so as to ensure that during installation, the pins 10 can be inserted into the connection mechanisms smoothly. As shown in FIG. 3, a pulling part 12 may be further disposed to pull the pin 10 upward (as indicated by the arrow in FIG. 3) and fix the pin 10 on a wall of the connection structure, so as to compensate for the gap between the pin and the connection structure, thereby fixing the strut 1 and the connection part 7 together. In the embodiment of the present invention, the second positions B, E are designed, so as to reduce or eliminate the local stress incurred at the junction of the head portion 3 and the root portion 4 of the strut of the equipment during the lifting, thereby protecting the strut 1. To facilitate connection of the connection part 7 and the strut 1, in the embodiment of the present invention, the diameter of the connection components such as pin 10 is smaller than the diameter of the first group or the second group of connection mechanisms which is connected to the connection components. Furthermore, the diameter of the connection components is also smaller than the diameters of the connection mechanisms 8, 9 on the strut 1.

Preferably, the third positions, for connecting to the root portion 4 of a strut 1, of two adjacent connection parts 7 are symmetrically disposed relative to the central axis of the root portion 4 of the strut.

Further, it should be noted that, the connection part 7 may not have only one pair of the first position and the second position A, B shown in FIG. 1. FIG. 4 is a schematic view of another embodiment of the present invention. An exhaust casing may have 8 outwardly extending struts 1, and a connection part 7 is provided with two pairs of the first position and the second position A, B (the first position is a position that bears a gravity load during lifting, and the second position is a position that balances a local load incurred during the lifting). In this way, a connection part 7 may be connected to two struts 1, so that the gravity load borne by a connection part 7 is distributed to two struts 1.

Persons skilled in the art may easily figure out that other connection mechanisms may be used to replace holes in the first positions, the second positions, and a third position on the connection part 7. The head portion 3 of the struts may be provided with other connection mechanisms instead of holes. However, since the head portions of the struts of some existing exhaust casing have holes, lifting can be performed with these holes saving the cost to prepare connection mechanisms during installation or maintenance. Meanwhile, holes at the second positions B, E of the connection part 7 may not be disposed, as shown in FIG. 1, on a front surface of the connection part 7, and may also be disposed at positions, such as a side surface or an outer surface of the connection part 7. The number of the connection mechanisms 8, 9 on the head portion 3 of the strut and the number of the first connection mechanism and the second connection mechanism 5, 6 on the connection part 7 may not be, as shown in FIG. 1, 2, and may also be 4, 6, and so on. Further, the number of the connection mechanisms 5, 6 at the first position and the second position A, B on the connection part 7 may not be equal to the number of the connection mechanisms 8, 9 on the head portion 3 of the strut. For example, the first connection structure and the second connection structure 5, 6 at the first position and the second position A, B may be less than the connection mechanisms 8, 9 on the head portion 3.

The connection mechanisms 8, 9 on the head portion 3 and the connection mechanisms 5, 6 on the connection part 7 may be symmetrical relative to the central axis of the root portion 4. However, an alternative in which the connection mechanisms 8, 9 on the head portion 3 and the connection mechanisms 5, 6 on the connection part 7 are asymmetrical relative to the central axis of the root portion also can work.

It should be noted that, the connection part 7 may not be, as shown in FIG. 1, provided with only one hole at each of the first position and the second position A, B and the third positions C, D. For example, multiple holes may exist at the first position and the second position, and multiple holes may exist at the third positions.

In the embodiments of the present invention, a plurality of separate connection parts, instead of a single connection part, are used to fix a plurality of the outwardly extending struts of the equipment respectively. In this manner each connection part can bear the gravity load of the equipment during lifting and balance the incurred local load at the positions on two sides of the center line of the root portion of the strut. In this way, the gravity load of the lifted equipment can be distributed to multiple struts, thereby the situation where the gravity load is concentrated on a strut is avoided. Meanwhile, the manner of the connection located on two sides of the central axis of the root portion of one strut can balance the local load on the strut incurred during lifting.

Although the device of the present invention is illustrated above with reference to the example of lifting the exhaust casing and the rotor of the gas turbine, persons skilled in the art can understand that the device of the present invention is not limited to lifting the exhaust casing and the rotor of the gas turbine. The device may be used to lift multiple kinds of heavy equipment having a plurality of struts, which include a generator, a motor, and so on.

It should be understood that, although the specification is described according to embodiments, it is not true that each embodiment includes only one independent technical solution. The description manner of the specification is only for clarity, persons skilled in the art shall regard the specification as a whole, and the technical solutions of the embodiments may also be combined appropriately to form other embodiments understandable to persons skilled in the art.

The above embodiments of the present invention are only exemplary, and are not intended to limit the scope of the present invention. Any equivalent change, modification, and combination made by persons skilled in the art without departing from the idea and principle of the present invention shall fall within the protection scope of the present invention.

1. A device for lifting equipment, comprising:
a plurality of outwardly extending struts, each of the plurality of struts including a head portion and a root portion connected to the head portion; and
a plurality of separate connection parts, each of the plurality of connection parts being capable of connection at a first position and a second position to the head portion of respective ones of the plurality of struts, and the first position and the second position being located on two sides of a central axis of a respective one of the plurality of struts, so that the first position and the second position are respectively capable of bearing a gravity load of the equipment and balancing a stress load which the respective strut incurs when the equipment is lifted by the device.

2. The device of claim 1, wherein the plurality of separate connection parts further include third positions at one end thereof, and wherein the third positions of two adjacent of the plurality of separate connection parts are located on two sides of a central axis of the root portion of one respective strut, so that the head portion of one respective strut is capable of connecting two adjacent of the plurality of separate connection parts at the third positions.

3. The device of claim 1, wherein each of the plurality of separate connection parts includes two pairs of the first position and the second position, so that each of the plurality of separate connection parts is capable of connecting two struts.

4. The device of claim 1, wherein the head portion of at least one of the plurality of struts includes connection mechanisms at the first position and the second position respectively, and wherein at least one of the plurality of separate connection parts includes a first group of connection mechanisms and a second group of connection mechanisms whose positions correspond to those of the connection mechanisms of the head portion of the respective at least one of the plurality of struts, so that the connection part is capable of being connected to the respective at least one of the plurality of struts at the first position and the second position respectively.

5. The device of claim 4, wherein the first group of connection mechanisms and the second group of connection mechanisms of the at least one of the plurality of separate connection parts and the connection mechanisms of the head portion of the at least one of the plurality of struts are all holes.

6. The device of claim 4, wherein one of the first group of connection mechanisms and the second group of connection mechanisms of the at least one of the plurality of separate connection parts forms a tight connection with the connection mechanisms of the head portion of the at least one of the plurality of struts, so that one position among the first position and the second position is capable of bearing the gravity load of the equipment.

7. The device of claim 6, wherein the other of the first group of connection mechanisms and the second group of connection mechanisms is capable of being connected to the connection mechanisms on the head portion of the at least one of the plurality of struts by connection components, and diameters of the connection components are relatively smaller than diameters of the connection mechanisms on the head portion of the at least one of the plurality of struts, and are also relatively smaller than diameters of the first group of connection mechanisms or the second group of connection mechanisms connected to the connection components.

8. The device of claim 2, wherein the connection parts are provided with third connection mechanisms at the third positions, and two adjacent of the plurality of separate connection parts are connected at the third positions to the head portion of a respective one of the plurality of struts through the third connection mechanisms.

9. The device of claim 1, wherein the first position and the second position are symmetrically located relative to the central axis of the root portion of the plurality of struts.

10. The device of claim 1, wherein the shape of the connection parts is an arc.

11. The device of claim 2, wherein the third positions of the two adjacent connection parts for connecting to the head portion of one of the plurality of struts are symmetrical relative to the central axis of the root portion of the respective strut.

12. The device of claim 11, wherein a lifting point for lifting the equipment is located between the third position and the first position or the second position which is closer to the third position.

13. The device of claim 1, wherein the equipment is a combination of an exhaust casing and a rotor of a gas turbine.

14. The device of claim 3, wherein the head portion of at least one of the plurality of struts includes connection mechanisms at the first position and the second position respectively, and wherein at least one of the plurality of separate connection parts includes a first group of connection mechanisms and a second group of connection mechanisms whose positions correspond to those of the connection mechanisms of the head portion of the respective at least one of the plurality of struts, so that the connection part is capable of being connected to the respective at least one of the plurality of struts at the first position and the second position respectively.

15. The device of claim 14, wherein the first group of connection mechanisms and the second group of connection mechanisms of the at least one of the plurality of separate connection parts and the connection mechanisms of the head portion of the at least one of the plurality of struts are all holes.

16. The device of claim 14, wherein one of the first group of connection mechanisms and the second group of connection mechanisms of the at least one of the plurality of separate connection parts forms a tight connection with the connection mechanisms of the head portion of the at least one of the plurality of struts, so that one position among the first position and the second position is capable of bearing the gravity load of the equipment.

17. The device of claim 16, wherein the other of the first group of connection mechanisms and the second group of connection mechanisms is capable of being connected to the connection mechanisms on the head portion of the at least one of the plurality of struts by connection components, and diameters of the connection components are relatively smaller than diameters of the connection mechanisms on the head portion of the at least one of the plurality of struts, and are also relatively smaller than diameters of the first group of connection mechanisms or the second group of connection mechanisms connected to the connection components.
